(19) United States
(12) Patent Application Publication
(10) Pub. No.: US 2020/0168365 A1
(43) Pub. Date: May 28, 2020

(54) CONDUCTIVE WIRE AND METHOD FOR MANUFACTURING CONDUCTIVE WIRE

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Mitsuru HIROSE, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/611,284

(22) PCT Filed: Apr. 23, 2018
(86) PCT No.: PCT/JP2018/016413

§ 371 Date: Nov. 6, 2019

(30) Foreign Application Priority Data
May 10, 2017 (JP) 2017-093872

(51) Int. Cl. H01B 11/04; H01B 13/02; H01B 7/18; H01B 7/00; H01B 5/08; H01B 3/30; B60R 16/02

(52) U.S. Cl. CPC H01B 11/04; H01B 13/02; H01B 7/18; B60R 16/0215; H01B 5/08; H01B 3/30; H01B 7/0009

(57) ABSTRACT

A multi-core power cable for supplying AC power to an electrical device, the multi-core power cable including a plurality of core wires that are non-insulated stranded wires or non-insulated single-core wires; an insulative Y-shaped spacer that includes a center that is a solid portion that is made of an insulative resin and that extends in a longitudinal direction, and three plate-shaped walls that are formed of an insulative resin and that extend outward in a radial direction from the center, and that are provided between the plurality of core wires and isolates the plurality of core wires from each other, the spacer being configured to position the plurality of core wires in a trefoil formation; and an insulative sheath that collectively covers an outside of the plurality of core wires.

### BACKGROUND

The present disclosure relates to a conductive wire and a method for manufacturing the conductive wire.

In vehicles such as electric cars and hybrid cars, high-voltage AC power is supplied from an inverter to various electrical devices via a high-voltage harness. The inverter converts DC voltage supplied from a battery to a desired high voltage and supplies the resultant high voltage to the various electrical devices. For this reason, conductive wires that supply AC power to the various electrical devices are connected to the inverter.

JP 2002-373730A discloses a molded connector via which three wires that output three-phase AC power supplied from an inverter are connected to devices.

### SUMMARY

Incidentally, in the above-described molded connector, since the three wires are arranged side by side, in other words, the three wires are arranged in parallel on the same plane, there is a problem in that a large space is required for routing the three wires.

An exemplary aspect of the disclosure provides a conductive wire that requires less routing space.

A conductive wire according to an aspect of the present disclosure includes a plurality of core wires, an insulative spacer that is provided between the plurality of core wires and isolates the plurality of core wires from each other, and a sheath that collectively covers the outside of the plurality of core wires.

With this configuration, the sheath collectively covers the outside of the plurality of core wires in a state where the core wires are isolated from each other by the insulative spacer. For this reason, compared to the case where, for example, a plurality of insulation-coated wires, each formed by coating a core wire with an insulating coating one by one, are arranged side by side, in other words, the insulation-coated wires are arranged in parallel on the same plane, the interval between the adjacent core wires can be shortened, and thus the routing space of the conductive wire can be reduced.

In the above-described conductive wire, it is preferable that the plurality of core wires are fixed to the spacer.

With this configuration, since the core wires are fixed to the spacer, it is possible to position the core wires and suppress positional displacement of the core wires.

In the above-described conductive wire, it is preferable that the spacer is formed of a thermoplastic resin.

With this configuration, since the spacer is formed of a thermoplastic resin, it is possible to soften the spacer by heating, and adhere the core wires to the spacer.

In the above-described conductive wire, it is preferable that the spacer and the plurality of core wires are configured to be exposed from an end of the sheath.

With this configuration, since it is not necessary to strip the sheath separately, workability in attaching terminals and the like can be improved.

A method for manufacturing a conductive wire according to another aspect of the present disclosure includes isolating a plurality of core wires from each other with an insulative spacer, heating the spacer to soften contact portions of the spacer that come in contact with the plurality of core wires, and thereafter curing the contact portions to fix the plurality of core wires to the spacer, and forming a sheath by injection molding so as to cover the spacer and the plurality of core wires that are fixed to each other.

According to this method, it is possible to provide a conductive wire that requires less routing space.

According to some aspects of the present disclosure, it is possible to provide a conductive wire that requires less routing space.

### BRIEF DESCRIPTION OF THE DRAWINGS

FIG. 1 is a perspective view of a conductive wire according to one embodiment.

FIG. 2 is a cross-sectional view of the conductive wire shown in FIG. 1.

FIGS. 3(a) to 3(c) are cross-sectional views for describing a method for manufacturing the conductive wire shown in FIG. 1.

### DETAILED DESCRIPTION OF EMBODIMENTS

Hereinafter, one embodiment of a conductive wire will be described with reference to the drawings. Note that in the drawings, parts of the configuration may be shown in an exaggerated or simplified manner for convenience of description. Moreover, dimensional ratios of various portions may be different from actual dimensional ratios.

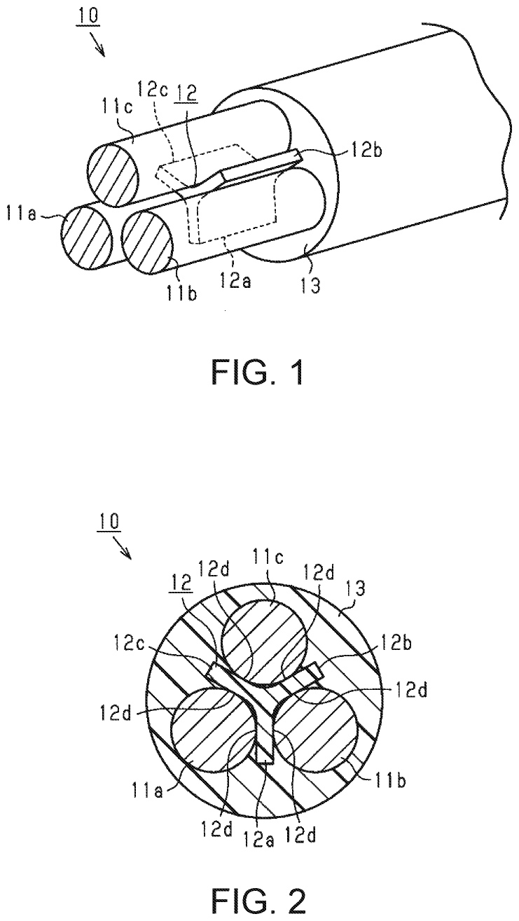

As shown in FIGS. 1 and 2, a conductive wire 10 of the present embodiment includes three core wires 11a to 11c, a spacer 12 that isolates the core wires 11a to 11c from each other, and a sheath portion 13 (sheath) that collectively covers the outside of the core wires 11a to 11c. Note that the conductive wire 10 of this example is used as a wire that electrically connects two electrical devices to each other in a vehicle or the like. The combination of the two electrical devices may conceivably be a travel drive motor in an electric automobile or the like and an inverter for driving the motor, a motor-driving inverter and a battery that supplies a power to the inverter, or the like. In this example, description will be given on the assumption that one electrical device is a motor (three-phase motor, etc.) and the other electrical device is an inverter.

The core wires 11a to 11c are each formed by a stranded wire or a single core wire, for example, and are configured to be substantially circular in cross-section.

The spacer 12 is formed of an insulative material such as a polyamide resin, a polyolefin resin, or the like. Note that the spacer 12 is preferably formed of a thermoplastic resin, for example.

As shown in FIGS. 1 and 2, the spacer 12 is substantially Y-shaped and includes a center portion (center) located in substantially the center of the conductive wire 10 in a radial direction (also referred to as an axis line), and three wall portions 12a to 12c (walls) that extend outward in the radial direction (radially) from the center portion. The wall portions 12a to 12c are provided at an equal angle interval (about 120 degrees). Note that, in FIGS. 1 and 2, boundary portions (also referred to as valley portions or valleys) of the wall portions 12a to 12c that are adjacent to each other in the circumferential direction are formed in a curved surface shape.

The wall portions 12a to 12c include contact portions 12d that come in contact with the core wires 11a to 11c. The contact portions 12d are formed by, for example, the softened wall portions 12a to 12c being brought in contact with the core wires 11a to 11c in a state where the wall portions 12a to 12c have been partly soften or melted by heating the wall portions 12a to 12c. The core wires 11a to 11c are adhered (fixed) to the wall portions 12a to 12c at the contact portions 12d. Note that a configuration is also possible where the wall portions 12a to 12c and the core wires 11a to 11c are stuck (fixed) to each other.

As shown in FIGS. 1 and 2, the sheath portion 13 is configured to cover the outside of the spacer 12 and the core wires 11a to 11c and form a circular outer shape. The sheath portion 13 is formed of an insulative material such as silicone or polyethylene, for example.

As shown in FIG. 1, the conductive wire 10 of the present embodiment is formed such that the spacer 12 and the core wires 11a to 11c are longer than the sheath portion 13, and the spacer 12 and the core wires 11a to 11c are exposed, or protrude in the longitudinal direction of the conductive wire 10, from an end portion of the sheath portion 13. A connector (not shown) is attached to the end portion of the conductive wire 10. More specifically, the core wires 11a to 11c exposed from the end portion of the sheath portion 13 are electrically connected to a plurality of terminals provided in the connector, respectively. Here, a housing that forms the connector is formed by injection molding, for example, so as to house the exposed end portions of the core wires 11a to 11c and the spacer 12 and covers the end portion of the sheath portion 13 from outside.

Next, a method for manufacturing the conductive wire 10 of the present embodiment will be described.

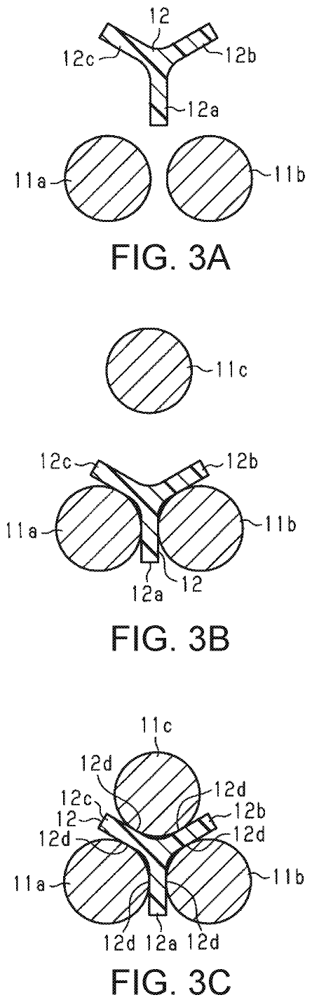

First, as shown in FIG. 3(a), one wall portion 12a of the spacer 12 is arranged so as to be interposed between the two core wires 11a and 11b.

As shown in FIG. 3(b), the core wire 11c is arranged between the wall portions 12b and 12c of the spacer 12 so as to come in contact with the wall portions 12b and 12c.

As shown in FIG. 3(c), the contact portions 12d of the wall portions 12a to 12c are initially soften (melted) by heating the wall portions 12a to 12c in a state where the core wires 11a to 11c are in contact with the contact portions 12d of the wall portions 12a to 12c of the spacer 12, and the contact portions 12d are cured after that, and thus the core wires 11a to 11c are adhered (fixed) to the wall portions 12a to 12c.

After that, the spacer 12 and the core wires 11a to 11c are set in a mold, the sheath portion 13 is formed by filling the mold with a resin material such as silicone or polyethylene, and the conductive wire 10 shown in FIGS. 1 and 2 is completed.

Next, the effects of the present embodiment will be described.

(1) The sheath portion 13 collectively covers the outside of the core wires 11a to 11c in a state where the core wires 11a to 11c are isolated from each other by the insulative spacer 12. For this reason, compared to the case where, for example, the plurality of insulation-coated wires each formed by coating a core wire with an insulating coating one by one are arranged side by side, in other words, the plurality of insulation-covered wires are arranged in parallel on the same plane, the interval between the adjacent core wires 11a to 11c can be made shortened, and thus the routing space taken by the conductive wire 10 can be reduced.

(2) Furthermore, it is possible to suppress the occurrence of a short circuit between the core wires 11a to 11c by the spacer 12.

(3) The core wires 11a to 11c are adhered (fixed) to the spacer 12, and thus it is possible to position the core wires 11a to 11c and suppress positional displacement of the core wires 11a to 11c.

(4) Since the spacer 12 is formed of a thermoplastic resin, it is possible to soften the spacer 12 by heating and adhere the core wires 11a to 11c to the spacer 12.

(5) The spacer 12 and the core wires 11a to 11c are configured to be exposed from the end portion of the sheath portion 13. Since it is not necessary to strip the sheath portion 13 separately, workability in attaching terminals and the like can be improved.

Note that the above-described embodiment may also be modified as described below.

Although it is not particularly mentioned in the above-described embodiment, a configuration is also possible in which the contact surfaces between the wall portions 12a to 12c of the spacer 12 and the core wires 11a to 11c correspond to the shape of the core wires 11a to 11c. If this configuration is applied to the above-described embodiment, the contact surfaces may also be formed in a curved surface shape that substantially conforms to the curved surface of the core wires 11a to 11c that have a circular cross-section.

Although the above-described embodiment describes the cross-section of the core wires 11a to 11c as being substantially circular, the present disclosure is not limited thereto. The cross-section may also be fan-shaped or polygonal.

Although the above-described embodiment describes the spacer 12 as being substantially Y-shaped so as to isolate the three core wires 11a to 11c from each other, the present disclosure is not limited thereto. It is also possible to adopt a configuration in which two core wires are isolated from each other by a spacer, or a configuration in which more than three core wires are isolated from each other by a spacer.

The above-described embodiment and variations can also be combined as appropriate.

Each of the core wires 11a, 11b, and 11c of the above-described embodiment may be referred to as a “non-insulated conductive wire” or a “non-insulated conductive core” in some cases. The conductive wire 10 of the above-described embodiment can function as a multi-core power cable or a 3-core power cable having the core wires 11a, 11b, and 11c. The assembly formed by the core wires 11a, 11b, and 11c and the spacer 12 shown in FIG. 3(c) may be referred to as a “core assembly” in some cases.

The spacer 12 of the above-described embodiment is preferably manufactured as a one-piece component, and can be formed of a first insulative resin material having thermoplasticity. The sheath portion 13 can be formed of a second insulative resin material that is different from the first insulative resin material, but the sheath portion 13 may also be formed of the first insulative resin material. The sheath portion 13 may also be referred to as an “electrically insulative cladding” that covers the core wires 11a, 11b, and 11c and the spacer 12. The sheath portion 13 is directly in contact with at least the outermost surface of the core wires 11a, 11b, and 11c, and at least the outermost surface of the spacer 12.

The spacer 12 of the above-described embodiment includes a center portion that is in parallel with the axis line of the conductive wire 10, and preferably concentric with the axis line of the conductive wire 10, and a plurality of wall portions that radially protrude from the center portion. When seen in the length direction of the conductive wire 10, the core wires 11a, 11b, and 11c are arranged so as to surround the center portion of the spacer 12, and may be arranged symmetrically with respect to the center portion of the spacer 12, for example.

The spacer 12 of the above-described embodiment may also be referred to as a “positioning separator” that positions the core wires 11a, 11b, and 11c so as to hold the core wires 11a, 11b, and 11c in parallel with each other in a non-contact manner by directly contacting each of the core wires 11a, 11b, and 11c. The positioning separator (12) may also be configured to position the core wires 11a, 11b, and 11c, preferably in a bundled state, and more preferably, in a trefoil formation.

The present disclosure includes the following configurations. The reference numerals of the constituent elements of the embodiment are given for assisting understanding, rather than as a limitation.

Supplementary note 1: A multi-core power cable (10) according to a specific implementation example is provided with a plurality of non-insulated conductive cores (11a, 11b, 11c), a positioning separator (12) that is an electrically insulative one-piece component and that is configured to position the non-insulated conductive cores (11a, 11b, 11c) by directly contacting each of the non-insulated conductive cores (11a, 11b, 11c), and an electrically insulative cladding (13) that covers the non-insulated conductive cores (11a, 11b, 11c) and the positioning separator (12).

Supplementary note 2: The positioning separator (12) is configured to position the non-insulated conductive cores (11a, 11b, 11c) in a trefoil formation.

Supplementary note 3: The positioning separator (12) is formed of a first insulative resin material having thermoplasticity, and the electrically insulative cladding (13) is formed of a second insulative resin material that is different from the first insulative resin material.

Supplementary note 4: The electrically insulative cladding (13) covers the non-insulated conductive cores (11a, 11b, 11c) and the positioning separator (12) excluding an end portion of the multi-core power cable (10).

Supplementary note 5: The electrically insulative cladding (13) is directly in contact with an outermost surface of the non-insulated conductive cores (11a, 11b, 11c) and an outermost surface of the positioning separator (12).

It will be apparent to a person skilled in the art that the present disclosure may also be realized in other specific embodiments without departing from the technical idea of the present disclosure. For example, some of the components described in the embodiments (or one or more aspects) may be omitted, or several components may be combined.

1. A multi-core power cable for supplying AC power to an electrical device, the multi-core power cable comprising:
a plurality of core wires that are non-insulated stranded wires or non-insulated single-core wires;
an insulative Y-shaped spacer that includes a center that is a solid portion that is made of an insulative resin and that extends in a longitudinal direction, and three plate-shaped walls that are formed of an insulative resin and that extend outward in a radial direction from the center, and that are provided between the plurality of core wires and isolates the plurality of core wires from each other, the spacer being configured to position the plurality of core wires in a trefoil formation; and
an insulative sheath that collectively covers an outside of the plurality of core wires.

2. The multi-core power cable according to claim 1, wherein
the plurality of core wires are fixed to the spacer.

3. The multi-core power cable according to claim 1, wherein
the spacer is formed of a thermoplastic resin.

4. The multi-core power cable according to claim 1, wherein
the spacer and the plurality of core wires are configured to be exposed from an end of the sheath.

5. The multi-core power cable according to claim 1, wherein
the sheath is directly in contact with an outermost surface of the plurality of core wires and the outermost surface of the spacer.

6. The multi-core power cable according to claim 1, wherein
the spacer includes three valleys that are defined between the three plate-shaped walls, and the spacer and the sheath are configured to position the plurality of core wires in with respect to the three valleys such that the plurality of core wires corresponds one-to-one to the three valleys.

7. The multi-core power cable according to claim 1, wherein
each of the plurality of core wires and the center extend in parallel with each other in the longitudinal direction.

8. The multi-core power cable according to claim 1, wherein the plurality of core wires are three core wires.

9. The multi-core power cable according to claim 1, wherein each of the plurality of core wires has a circular cross section.

10. A method for manufacturing a multi-core power cable, the method comprising:
preparing an insulative Y-shaped spacer that includes a center that is a solid portion that is made of an insulative resin and that extends in a longitudinal direction, and three plate-shaped walls that are formed of an insulative resin and that extend outward in a radial direction from the center;
isolating a plurality of core wires that are non-insulated stranded wires or non-insulated single-core wires from each other with the three plate-shaped walls of the spacer, and positioning the plurality of core wires with the spacer in a trefoil formation;
heating the spacer to soften contact portions of the spacer that come in contact with the plurality of core wires, and thereafter curing the contact portions to fix the plurality of core wires to the spacer; and
forming a sheath by injection molding so as to cover the spacer and the plurality of core wires that are fixed to each other.
